(19) United States
(12) Patent Application Publication
(10) Pub. No.: US 2018/0282053 A1
(43) Pub. Date: Oct. 4, 2018

(54) CONTAINER CAP AND CONTAINER HAVING SAME COUPLED THERETO

(71) Applicant: Jin Hee AHN, Yongin-si, Gyeonggi-do (KR)

(72) Inventor: Jin Hee AHN, Yongin-si, Gyeonggi-do (KR)

(21) Appl. No.: 15/744,562

(22) PCT Filed: Jul. 13, 2016
(86) PCT No.: PCT/KR2016/007626

§ 371 Date: Jun. 18, 2018

(30) Foreign Application Priority Data
Jul. 13, 2015 (KR) 10-2015-0100457

(51) Int. Cl. B65D 83/04; B65D 83/06; A61J 1/03

(52) U.S. Cl. CPC B65D 83/049; B65D 47/20; A61J 1/03; B65D 83/06

(57) ABSTRACT

In a finished product used by coupling a 2-piece bottle cap formed of a cover and a body to the opening of a bottle, everything relating to the bottle cap having the body or the cover of various structures in which a desired number of the contents stored in the inner space of the bottle is left remained in a keeping groove when the cover coupled by screw threads to the body is opened after the finished product is turned 90-180 degrees upside down from an upright standing position and then rotated to the upright position, is disclosed.

### TECHNICAL FIELD

The present invention relates to a bottle cap and a bottle coupled with the same, in which the bottle stores contents in grain form and the cap coupled with the bottle inlet.

### BACKGROUND ART

In accordance with the conventional art, when a user opens the bottle and takes out the contents stored in the bottle, more pieces than needed are discharged out, and then some pieces are put into the bottle again. So, there are the problems that the contents(pieces, grain) in the bottle are contaminated from the contamination materials by being contacted with user's handprints and fingers.

In addition, there are the problems that the contents(pieces) stored in the bottle are contaminated from the water because the discharged contents on which the water may remain from user's handprints and fingers are put into the bottle.

FIG. 1 is a sectional view showing a bottle coupled with a bottle cap in accordance with the conventional art.

The bottle cap 1 in accordance with the conventional art, is coupled with the bottle inlet 12 of the bottle 10 containing contents 73 in grain form within the inside 56.

And the contents 73 in the grain form, are piled from the bottom 57 of the bottle 10, the user (only once) separates the bottle cap 1 and the sealing member 71 attached to the bottle inlet 12 from the bottle inlet 12 and takes out some pieces of contents 73 in the grain form.

Here, a female screw portion 7 screw-connected with the male screw portion 54 formed on the outer circumferential surface of the bottle inlet 12 is formed on the inner circumferential surface of the bottle cap 1, and a plurality of knurls are formed on the outer circumferential surface of the bottle inlet 12 so that the user may easily grip and rotate the bottle cap 1.

Meanwhile, during the use of the bottle cap in accordance with the conventional art having the above-mentioned structure, such as the removal of the sealing member and the discharge of the contents together with simple opening of the bottle inlet, there are sanitary problems such as the contaminations from the user's hand and the inflow of the external materials.

So, the inventor of the present invention has tried to solve the above sanitary problems such as the contaminations from the user's hand and the inflow of the external materials during the removal of the sealing member and the discharge of the contents together with simple opening of the bottle inlet via the Korean patent application Nos. 2014-0123827 and 2014-0196112 of which the inventor and the applicant are the same as in the present application.

But there are some problems in the inventions (prior arts) disclosed in the Korean patent application Nos. 2014-0123827 and 2014-0196112, the present invention is to complement the two prior arts by proposing four methods (refer to embodiments of the present invention) and solve the above problems by improving the structure of the bottle cap (cover and the body of the bottle cap).

### DISCLOSURE

### Technical Problem

In order to solve the problems of the conventional Art, an object of the present invention is to provide a bottle cap and the bottle a bottle coupled with the same capable of taking out the contents stored in the bottle in the number of contents required by the user.

### Technical Solution

To accomplish the above object in accordance with the present invention, there is provided a bottle cap which includes a bottle cap body 100 coupled with a bottle inlet 12 of a bottle 10 storing the contents in grain form and formed with an outlet 102 discharging the contents stored in the bottle 10; a keeping unit 300 provided with inside of the bottle cap body 100, the keeping unit 300 being formed with at least one keeping groove 302 in which the contents discharged through the outlet 102 are accommodated; a contents removing unit 400 for dropping the contents other than the contents contained in the keeping groove 302 from the keeping unit 300 to the bottle 10.

The bottle cap may further include a cover 200 connected with the bottle cap body 100, the cover 200 uncover the keeping groove 302 to the outside after the bottle 10 is turned upside down and the contents are stored in the keeping groove 302.

Here the contents removing unit 400 may be connected with at least one of the bottle cap body 100 and the cover 200.

The contents removing unit 400 may include a protrusion unit 402 for dropping the contents other than the content contained in the keeping groove 302 into the bottle 10 while passing through the keeping groove 302 by at least one movement of linear movement and rotation movement, the protrusion unit 402 being formed by being protruded in a direction toward the bottle cap body 100 from the surface of the cover 200 facing the bottle cap body 100.

The cover 200 may be rotatably coupled to the bottle cap body 100, and the contents removing unit 400 may include a protrusion unit 402 for dropping the contents other than the content contained in the keeping groove 302 into the bottle 10 while passing through the keeping groove 302 by relative rotation of the cover 200 and the bottle cap body 100.

The contents removing unit 400 may be formed integrally with the cover 200 by being protruded from the bottom surface of the cover 200.

The cover 200 may be coupled with the bottle cap body 100 by undercut structure or screw structure.

The cover 200 may be formed with an assistant opening 202 in order to discharge the contents contained in the keeping groove 302 to the outside.

The cover 200 may be coupled with an opening/closing unit 500 which opens and closes the assistant opening 202 by at least one movement of linear movement and rotation movement with respect to the cover 200.

Then the protrusion unit 402 may be formed in the opening/closing unit 500.

The opening/closing unit 500 may be linearly moved horizontally with the bottom surface of the cover 200.

The outlet 102 may be is formed at a position corresponding to the keeping unit 300, the bottle cap body 100 is coupled with an opening/closing unit 500 which opens and closes the outlet 102 by at least one movement of linear movement and rotation movement with respect to the bottle cap body 100.

Here the contents removing unit 400 may include a protrusion unit 402 for dropping the contents other than the contents contained in the keeping groove 302 into the bottle 10 while passing through the keeping groove 302 by at least one movement of linear movement and rotation movement, the protrusion unit 402 being formed by being protruded in a direction toward the keeping unit 300 from the surface of the opening/closing unit 500 facing the keeping unit 300.

Also there is provided a bottle cap which includes a bottle cap body 100 coupled with a bottle inlet 12 of a bottle 10 storing the contents in grain form and formed with an outlet 102 discharging the contents stored in the bottle 10; a keeping unit 300 provided with inside of the bottle cap body 100 at a position corresponding to the outlet 102, the keeping unit 300 being formed with at least one keeping groove 302 in which the contents discharged through the outlet 102 are accommodated; an opening/closing unit 500 for opening and closing the outlet 102 by at least one movement of linear movement and rotation movement with respect to the bottle cap body 100.

The opening/closing unit 500 may be linearly moved horizontally with the bottom surface of the bottle cap body 100.

The opening/closing unit 500 may be rotatably installed centering a hinge shaft in parallel with the bottom surface of the bottle cap body 100.

The opening/closing unit 500 may include an opening/closing portion 520 for opening and closing the outlet 202 by being rotated centering the hinge shaft; a blocking portion 530 for blocking the inside of the bottle and the outlet 102 when the opening/closing portion 520 is opened, the blocking portion 530 being extended opposite to the opening/closing portion 520.

The keeping groove 302 may have a shape corresponding to a portion of the outer shape of one of contents so that one content is contained therein.

As means for solving the above problems, the present invention is to complement the two prior arts having some problems in the inventions disclosed (the Korean patent application Nos. 2014-0123827 and 2014-0196112) by proposing four methods (refer to embodiments of the present invention) and firstly solve the above problems by improving the structure of the screw bottle cap (a cover and a bottle cap body).

In more detail, the keeping groove 302 in various shapes is integrally or separately installed in an identical position of the bottle cap.

The contents removing unit 400 is integrally installed in the bottom of block plate 3 of the cover 200.

The structure of the keeping groove 302 is installed by adjusting the size and the shape so as to store a predetermined number of pieces or a predetermined amount of powder. The size and the shape of the keeping groove 302 will be described in detail with reference to the drawings.

The keeping groove 302 is installed in three ways, 1) integrally or separately from the bottom of the cap block plate 3, 2) integrally with the bottle cap body 100 in the inner space or the vertical upper surface of the bottle inlet 12, 3) on the outer surface of the side of the bottle inlet 12.

The method for using the developed product is such that the finished product (the cap+ the bottle) having the keeping groove 302 is inverted in an angle of 90 to 180 degrees and then the cap is opened again in the direction of opening the cap so as to be stored in the keeping groove for storing a desired number of pieces.

The detailed explanation will be described in detail in the four embodiments shown in the drawings and [Best Mode].

### Advantageous Effects

The present invention in order to solve the problems of conventional art has the following advantages.

The bottle cap in accordance with the present invention may take out the desired number or amount of the pieces from the bottle, and the operation is simple.

Also, the bottle cap in accordance with the present invention has the advantage that the pieces stored in the bottle may be cleanly used up to the end since the desired number or amount of the pieces are not exposed to the outside.

Also, the bottle cap in accordance with the present invention has the advantage that no additional facility cost is required for production since it is possible to combine the bottle cap with the same assembly method as in the conventional bottles.

### DESCRIPTION OF DRAWINGS

FIG. 1 is a sectional view of a product in accordance with the prior art, as a bottle cap coupled with an inlet of the bottle.

FIG. 2 is a sectional view showing a bottle cap coupled to the bottle inlet in accordance with the present invention.

FIG. 3 is a plan view showing a bottle cap having a contents removing unit in accordance with the present invention.

FIG. 4 is a partially enlarged sectional view showing a bottle cap with a contents removing unit in accordance with the present invention.

FIG. 5 is a sectional view of a keeping groove in accordance with the present invention.

FIG. 6 is a plan view of a keeping groove in accordance with the present invention.

FIG. 7a is a plan view showing a bottle cap before a certain amount contents other than the contents are removed from a keeping unit and FIG. 7b is a plan view showing a bottle cap after a certain amount contents other than the contents are removed from a keeping unit.

FIG. 8a is a sectional view showing a bottle cap before a certain amount contents other than the contents are removed from a keeping unit and FIG. 8b is a sectional view showing a bottle cap after a certain amount contents other than the contents are removed from a keeping unit.

FIG. 9a is a perspective view showing a contents removing unit of FIG. 8a and FIG. 8b; FIG. 9b is a bottom plan view a bottle cap a contents removing unit of FIG. 8a and FIG. 8b.

FIG. 10 is a perspective view of a bottle cap with an opening/closing unit hinged and coupled to a block plate of the bottle cap in accordance with the present invention.

FIG. 11 is a sectional view of the cover in FIG. 10.

FIG. 12a, FIG. 12b and FIG. 12c are sectional views showing process of removing a certain amount contents other than the contents from a keeping unit in a bottle cap in accordance with the present invention.

FIG. 13a, FIG. 13b and FIG. 13c are plan views showing process of removing a certain amount contents other than the contents from a keeping unit in a bottle cap in accordance with the present invention.

FIG. 14a to FIG. 14e are plan views of a keeping groove provided in a keeping unit in accordance with the present invention.

FIG. 15 is a sectional view showing a keeping groove storing contents provided in a keeping unit in accordance with the present invention.

FIG. 16 is an enlarged sectional view showing a part where a dehumidifying agent case is mounted to a bottom of a keeping groove in accordance with the present invention.

FIG. 17 is an enlarged bottom plan view showing a part where a dehumidifying agent case is mounted to a bottom of a keeping groove in accordance with the present invention.

FIG. 18 is a plan view showing a cover that is coupled by screw threads to the bottle cap body, with a disconnection plate and a removing ring in accordance with the present invention.

### BEST MODE

Herein, the bottle cap in accordance with the present invention will be described with reference to the attached drawings.

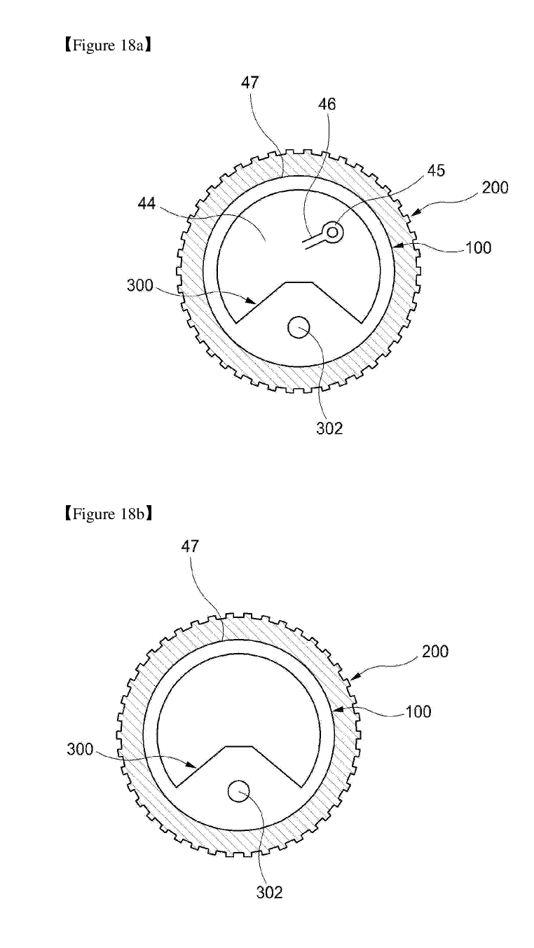

The bottle cap in accordance with the present invention, as shown in FIG. 2 and FIG. 18, includes a bottle cap body 100 coupled with a bottle inlet 12 of a bottle 10 storing the contents in grain form and formed with an outlet 102 discharging the contents stored in the bottle 10;

a keeping unit 300 provided with inside of the bottle cap body 100, the keeping unit 300 being formed with at least one keeping groove 302 in which the contents discharged through the outlet 102 are accommodated;

a contents removing unit 400 for dropping the contents other than the contents contained in the keeping groove 302 from the keeping unit 300 to the bottle 10.

The bottle cap body 100 may be configured in various ways to be coupled with the bottle inlet 12 of the bottle 10 storing the contents.

Herein, the contents may be various materials having a grain form or a particle shape. As an example, the contents may be gum, pills (granules). Furthermore, the example in case of the contents being pills is described as an example, but the scope of the present invention is not limited thereto.

The bottle cap body 100 may have an outlet 102 discharging the contents stored in the bottle 10 on a surface covering the bottle inlet 12.

The bottle cap body 100 may be coupled to the bottle by undercut structure or screw structure.

The keeping unit 300 may be provided inside the bottle cap body 100, as an element for providing a space where a predetermined amount of the pieces are placed before taken out by a user.

Also, the keeping unit 300 may be configured in various ways to be formed with at least one keeping groove 302 in which the contents discharged through the outlet 102 are accommodated.

The keeping unit 300 may be coupled to the inside of the bottle cap body 100 or may be integrally formed with the inside of the bottle cap body 100.

As shown in FIG. 2, it is preferable that a portion of the keeping unit 300 except for the keeping groove 302 on the upper surface thereof is formed in flat in order to position the pieces discharged through the outlet 102 of the bottle cap body 100.

Here, the bottle cap may further include a cover 200 coupled with the bottle cap body 100 for opening the keeping groove 302 to the outside after the bottle 10 is turned upside down and the contents are stored in the keeping groove 302.

The cover 200 may be coupled with the bottle cap body 100 by undercut structure or screw structure.

Therefore, when the user turns upside down the bottle 10 in the range of 90° to 180°, the pieces can be moved through the outlet 102 to the space between the keeping unit 300 and the cover 200. And, when the user turns again the bottle 10 back to its original state, the pieces cannot be moved back into the bottle 10 by the keeping unit 300 and can be placed on the upper surface of the keeping unit 300 or the keeping groove 302.

The keeping groove 302 may have a variety of plan shapes depending on the shape and the size of the pieces and may be formed at various depths.

As an example, the keeping groove 302 may have a shape corresponding to a part of the outer shape of the contents so as to contain one content or a plurality of contents.

For example, as shown in FIG. 15a to FIG. 15c, the keeping groove 302 may separately accommodate one piece by having a shape corresponding to the pieces, or accommodate a plurality of pieces.

The keeping groove 302 may be detachably coupled with the keeping unit 300 separately from the keeping unit, or may be integrally formed with keeping unit 300.

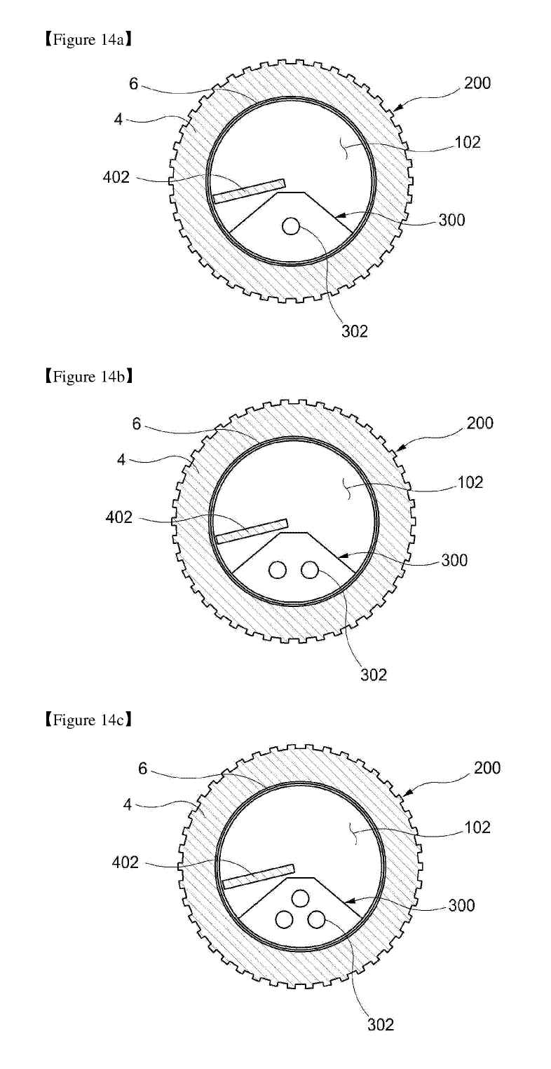

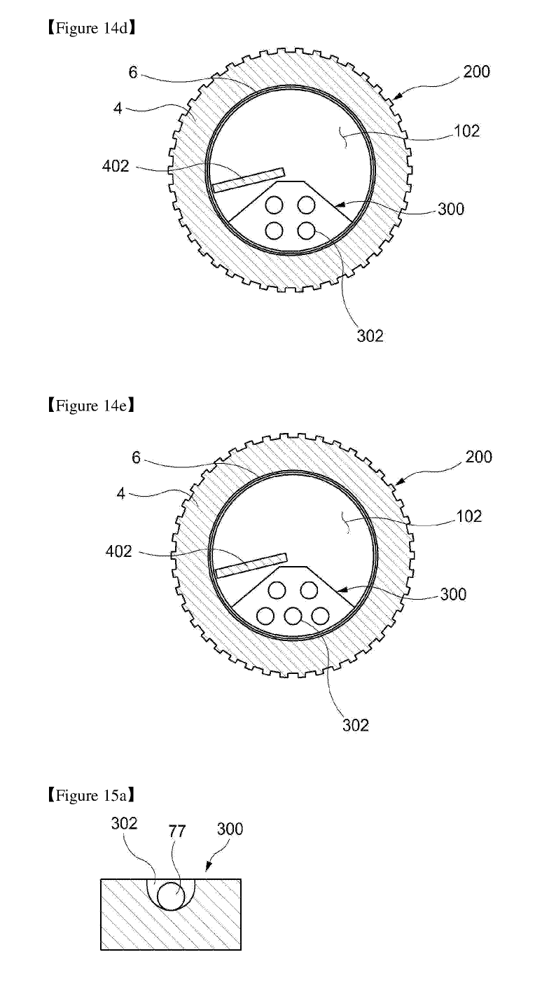

As an example, the keeping groove 302 may be formed as a plurality of, as shown in FIG. 14b to FIG. 14e.

Here, each of the plurality of keeping groove 302 may be formed to accommodate only one piece or accommodate a plurality of pieces.

For example, when the predetermined amount is three pieces, the keeping unit 300 may include three keeping grooves 302 respectively accommodating each one piece.

Meanwhile, in order to take out a predetermined amount of pieces, a configuration for removing the pieces other than a constant amount of pieces required by the user from the keeping unit 300 is additionally required. (for example, the case that the user requires 3 pieces in a predetermined amount of pieces, but 5 pieces are placed in the keeping unit 300)

Accordingly, the present invention may include a contents removing unit 400 for dropping the contents other than the contents contained in the keeping groove 302 from the keeping unit 300 to the bottle 10

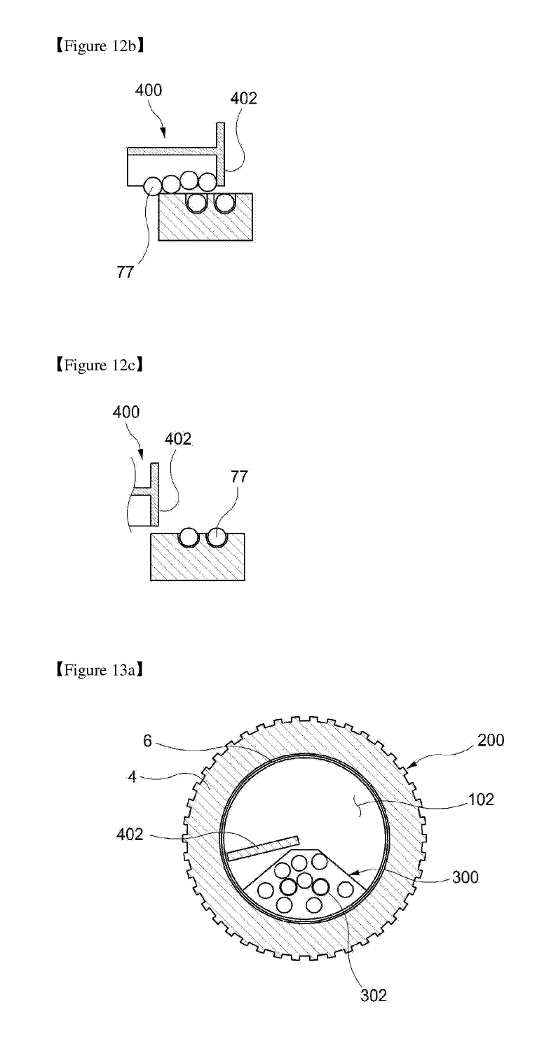

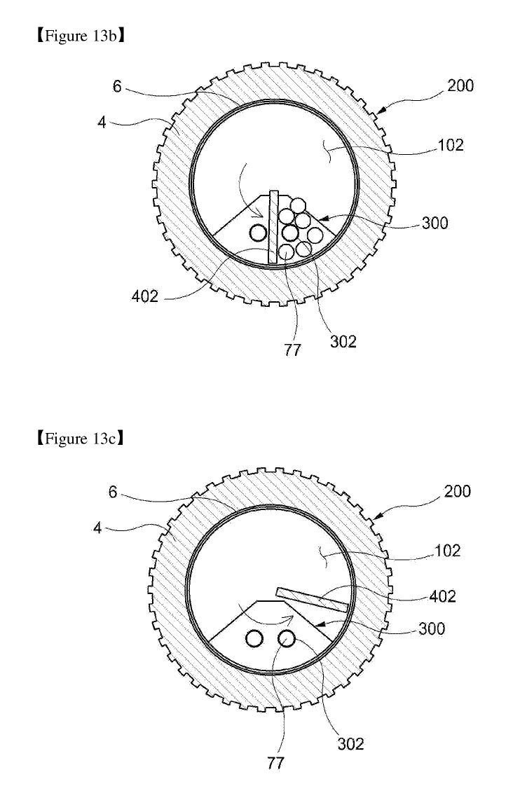

As shown in FIG. 12a to FIG. 13c, the contents removing unit 400 may be a variously configured in such a configuration that the pieces, positioned on one surface of the keeping unit 300 without being accommodated in the keeping groove 302, are placed in the empty keeping groove 302 when there is the empty keeping groove 302 and dropped into the bottle again when there is no empty keeping groove 302.

The contents removing unit 400 may be coupled to at least one of the bottle cap body 100 and the cover 200.

For example, the contents removing unit 400 may include a protrusion unit 402 for dropping the contents other than the content contained in the keeping groove 302 into the bottle 10 while passing through the keeping groove 302 by at least one movement of linear movement and rotation movement, the protrusion unit 402 being formed by being protruded in a direction toward the bottle cap body 100 from the surface of the cover 200 facing the bottle cap body 100.

More specifically, when the cover is rotatably coupled to the bottle cap body 100, as shown in FIG. 2 to FIG. 4, the contents removing unit 400 may include the protrusion unit 402 which drops the contents other than the content contained in the keeping groove 302 into the bottle 10 while passing through the keeping groove 302 by the relative rotation of the cover 200 and the bottle cap body 100.

In other word, the protrusion unit 402 is formed integrally with the cover 200 by being protruded from the surface (bottom surface) of the cover 200 facing the bottle cap body 100 and may be rotated together with the rotation of the cover 200.

For example, in case that the cover 200 is screw-coupled to the bottle cap body 100, when the user rotates the cover 200 in order to attach or detach the cover 200 from the bottle cap body 100, the protrusion unit 402 may be rotated together with the cover 200 to be moved relative to one surface of the keeping unit 300.

In one embodiment, when an assistant opening 202 is formed in the cover 200 for discharging the contents contained in the keeping groove 302 to the outside, the bottle cap may further include an opening/closing unit 500 coupled to the cover 200 and opening and closing the assistant opening 202 by at least one movement of linear movement and rotation movement with respect to the cover 200.

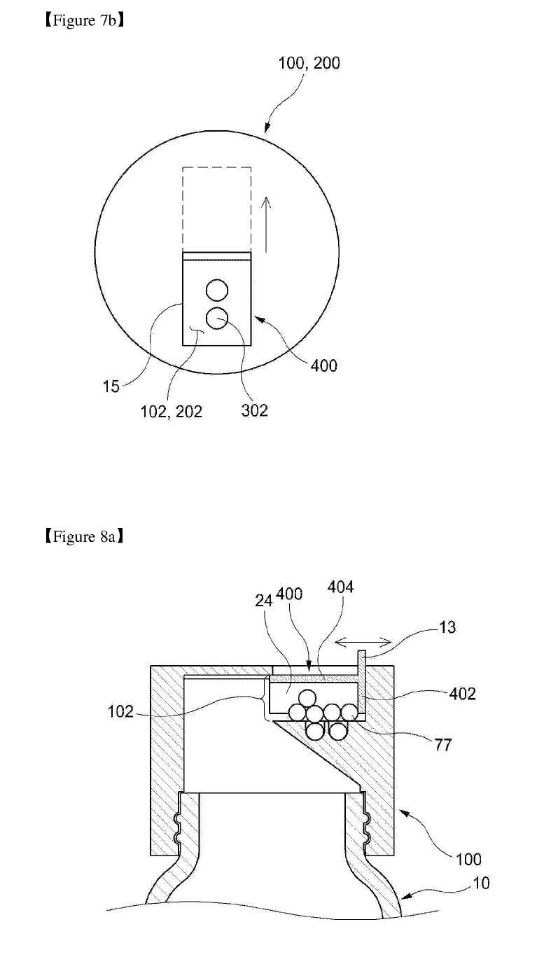

Here, as shown in FIG. 7a to FIG. 9, the protrusion unit 402 may be formed in the opening/closing unit 500.

The opening/closing unit 500 may be linearly moved horizontally with the bottom surface of the cover 200.

In another embodiment, when an outlet 102 is formed at a position corresponding to the keeping unit 300, the bottle cap may further include an opening/closing unit 500 coupled to the bottle cap body 100 and opening and closing the assistant opening 202 by at least one movement of linear movement and rotation movement with respect to the bottle cap body 100.

Here, the contents removing unit 400 being formed by protruding in a direction toward the keeping unit 300 from the surface of the opening/closing unit 500 facing the keeping unit 300 may include a protrusion unit 402 for dropping the contents other than the contents contained in the keeping groove 302 into the bottle 10 while passing through the keeping groove 302 by at least one movement of linear movement and rotation movement.

More specifically, the contents removing unit 400 may include a slide plate 404 coupled to the bottle cap body 100 so as to be movable in a horizontal direction relative to the bottle cap body 100 in a configuration independent of the bottle cap body 100 and the protrusion unit 402 protruding from a surface of the slide plate 404 facing the keeping unit 300 in the direction toward the keeping unit 300.

The slide plate 404 may be configured in various ways to open and close the outlet 102 relative to the bottle cap body 100 in a horizontal direction with respect to the bottle cap body 100.

For example, the slide plate 404 may be formed with a coupling protrusion on a surface parallel with the relative movement direction so as to be relatively movably coupled with the bottle cap body 100.

In case that the slide plate 404 is linearly moved in the direction toward the center of the bottle cap body 100, the coupling protrusion may be coupled with a coupling part formed in a linear moving direction on one surface of the bottle cap body 100.

The protrusion unit 402 may be configured in various ways to protrude from the surface of the slide plate 404 facing the keeping unit 300 so as to drop the contents other than the contents contained in the keeping groove 302 of the upper surface (the surface where the contents is placed) of the keeping unit 300 into the bottle 10.

When the slide plate 404 is linearly moved, the protrusion unit 402 is preferably formed in a direction perpendicular to the direction of the linear movement.

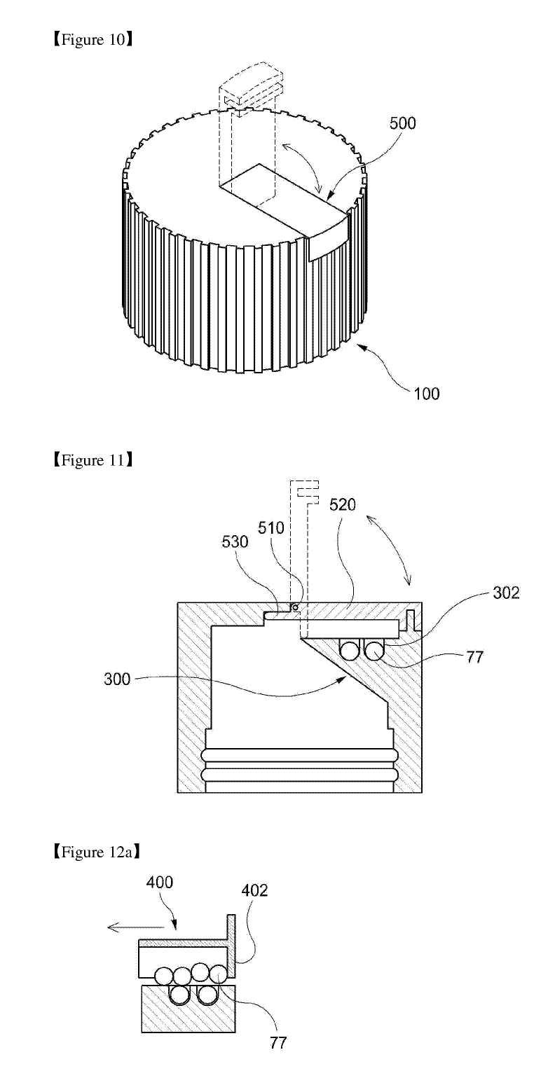

As shown in FIG. 10 and FIG. 11, a bottle cap in accordance with another aspect the present invention includes a bottle cap body 100 coupled with a bottle inlet 12 of a bottle 10 storing the contents in grain form and formed with an outlet 102 discharging the contents stored in the bottle 10; a keeping unit 300 provided with inside of the bottle cap body 100 at a position corresponding to the outlet 102, the keeping unit 300 being formed with at least one keeping groove 302 in which the contents discharged through the outlet 102 are accommodated; an opening/closing unit 500 for opening and closing the outlet 102 by at least one movement of linear movement and rotation movement with respect to the bottle cap body 100.

In one embodiment, the opening/closing unit 500 may be linearly moved horizontally with the bottom surface of the bottle cap body 100 by being coupled with the bottle cap body 100 at a position corresponding to the outlet 102 of the bottle cap body 100.

In another embodiment, the opening/closing unit 500 may be installed to be rotatable centering a hinge shaft 510 parallel with the bottom surface of the bottle cap body 100 by being coupled with the bottle cap body 100 at a position corresponding to the outlet 102 of the bottle cap body 100.

More specifically, as shown in FIG. 10 and FIG. 11, the opening/closing unit 500 may include an opening/closing portion 520 for opening and closing the outlet 202 by being rotated centering the hinge shaft 510; and a blocking portion 530 for blocking the inside bottle and the outlet 102 when the opening/closing portion 520 is opened by being extended opposite to the opening/closing portion 520.

In case that the outlet 102 is formed in a polygonal shape, the opening/closing unit 500 may be rotated with a hinged side as the hinge shaft 510 by being hinged to one surface of the sides of the polygon.

The blocking portion 530 may block the inside of the bottle and the outlet 102 when the opening/closing portion 520 is opened because the blocking portion 530 is formed to be extended opposite to the opening/closing portion 520.

The blocking portion 530 is preferably positioned on the upper surface of the keeping unit 300 when the opening/closing portion 520 is opened.

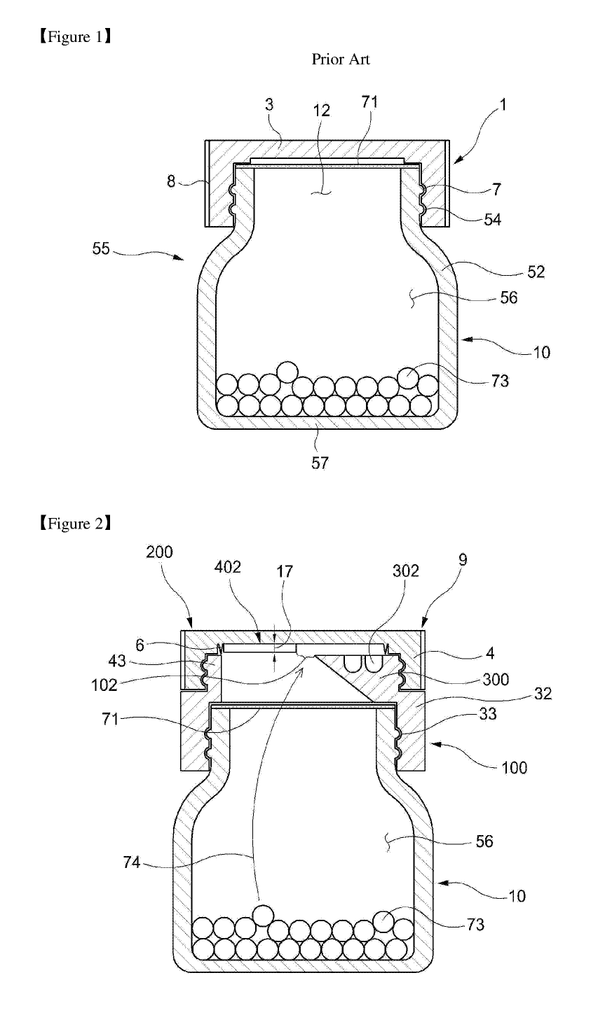

Hereinafter, embodiments of the present invention will be described in more detail with reference to FIG. 1 to FIG. 18.

First, FIG. 1 is a sectional view of a product in accordance with the prior art having a screw bottle cap at the inlet of the bottle. It is the sectional view of a basic finished product in which a bottle cap is fastened to a bottle inlet 12 as a generalized product.

As shown in FIG. 1, there are problems of the conventional art as the structure that a predetermined amount of contents required by the user cannot be taken out and used.

Next, embodiments of the present invention will be described with reference to FIG. 2 to FIG. 6.

FIG. 2 is a sectional view showing a bottle cap coupled to the bottle inlet in accordance with the present invention. It is the sectional view of a finished product in which a newly developed cap (the cover 200+the bottle cap body 100) is fastened to a bottle inlet 12 in which contents 73 are stored in an inside space 56. The bottle cap body 100 and the outer surface of the bottle inlet 12 are coupled by screw threads 33, 54 or undercut. The bottle cap body 100 and the cover 200 are coupled with each other by screw threads 7, 33. The cover 200 is formed by a block plate 3 and a side wall 4. The protrusion unit 402 is integrally installed on the bottom surface 16 of the block plate 3. The protrusion unit 402 extends from the center of the block plate to the right angle connecting part 9 and is installed in at least one as a bar. The maximum protruding height 17 of the protrusion part should not touch the keeping unit 300. The bar shape of the protrusion unit 402 is basic, and it is installed in various shapes depending on conditions.

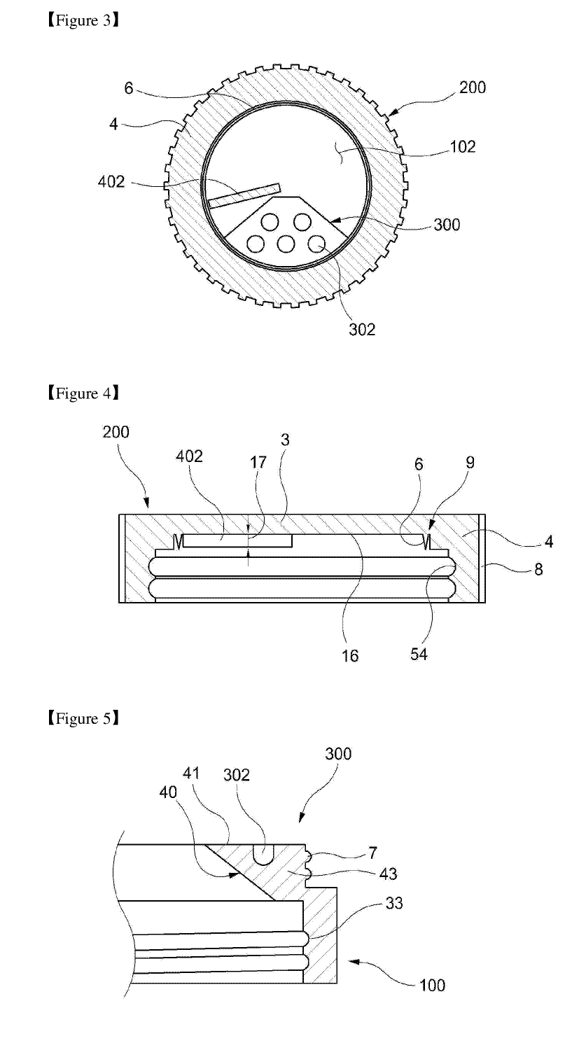

FIG. 3 is a plan view showing a bottle cap with a protrusion part in accordance with the present invention. Refer to the description of FIG. 2.

FIG. 4 is a partially enlarged sectional view showing a bottle cap with a protrusion part in accordance with the present invention. The protrusion unit 402 is installed in protruding at least one on the bottom surface 16 of the block plate 3 of the cover 200. The protrusion height 17 should be shorter than the interval between the bottom surface 16 of the block plate 3 and the keeping unit 300.

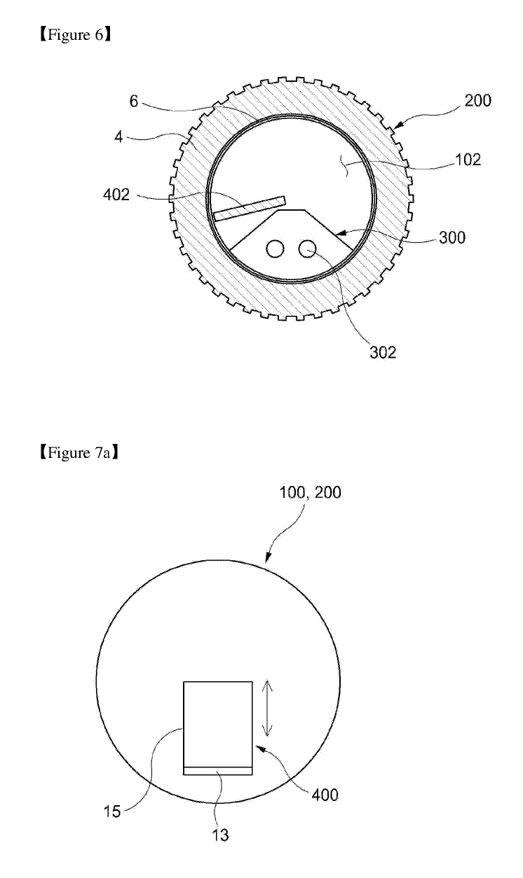

FIG. 5 is a sectional view of a keeping groove 302 in accordance with the present invention. It is integrally installed with the inside wall of the bottle cap body 100. It is always smaller than the inner diameter of the body. It includes at least one keeping unit 300 and a keeping groove 302. It has at least one keeping groove 302. The keeping groove 302 of the keeping unit 300 is installed horizontally as a basic type. The keeping unit 300 has at least one keeping groove 302. The keeping groove 302 has basic type in which a hollow cup-shaped/cylindrical-shaped with top opening. The diameter of the keeping groove 302 should always be smaller than the keeping unit 300. The bottom surface of the keeping groove 302 is provided with a groove or grip type device capable of fitting a product such as a dehumidifying agent 72 therein.

FIG. 6 is a plan view of a keeping groove in accordance with the present invention. Refer to the description of FIG. 5.

Next, as shown in FIG. 7 to FIG. 9b, another embodiment of the present invention will be described.

FIG. 7a is a plan view showing a bottle cap before a certain amount contents other than the contents are removed from a keeping unit and FIG. 7b is a plan view showing a bottle cap after a certain amount contents other than the contents are removed from a keeping unit.

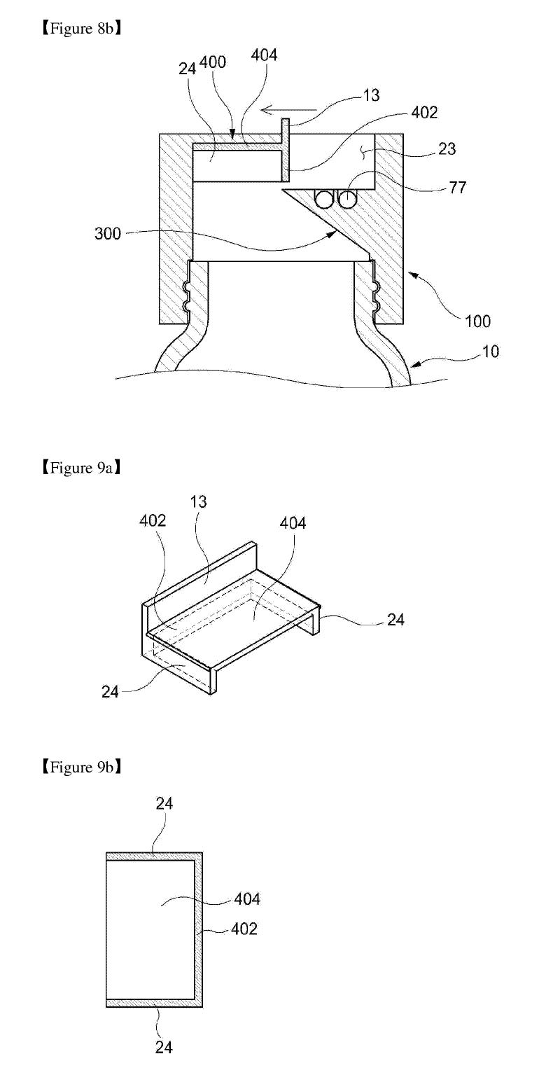

The size of the slide plate 404 should always be smaller than the circumferential size of the block plate. The slide plate 404 is constituted by a slide plate body 22, an emboss type coupling jaw 15, a grip 13 and a fence wall 24, and may have a protrusion unit 402 on one surface thereof. The emboss type coupling jaws 15 are provided on the four sides of the quadrangular slide plate 404 and the bottom surface of the slide plate is vertically provided with walls of predetermined height on three sides. The space inside three sides of the bottom surface of the slide plate is empty. There is fence wall 24 having a predetermined vertical height on both sides facing each other in the opening/closing direction of the four sides. The function of the fence wall 24 acts as a fence so that the content does not deviate from both sides of the keeping unit 300 when entering the keeping unit 300. The removing jaw 21 is installed in the direction of the surface of the side wall 4 of the body, and its function is to push the contents of the keeping unit 300 except the contents stored in the keeping groove 302 back into the bottle when the slide plate 404 is advanced in the opening direction. The remained side is open. On one end of the slide plate 404, a grip 13 having a proper length is provided in the upper direction and a protrusion part 404 having a proper height is provided in the downward direction. Refer to FIG. 9a and FIG. 9b for details.

When the slide plate 404 is pushed toward the center of the circumference, the assistant opening 202 of the cover 200 is exposed. The assistant opening 202 with upper and lower openings is provided in the block plate 3 on which the slide plate 404 is mounted. The slide plate 404 is sized to completely cover the assistant opening 202, and the emboss type coupling jaw 15 is installed at the four sides of the assistant opening 202. The emboss type coupling jaw 15 is also installed at the four sides of the slide plate 404. The slide plate 404 is detachable from the block plate 3. The method of coupling the two emboss type coupling jaws 15 is to use a convex-concave structure. The slide plate 404 serves to open and close the assistant opening 202 just above the keeping unit 300.

FIG. 8a is a sectional view showing a bottle cap before a certain amount contents other than the contents are removed from a keeping unit and FIG. 8b is a sectional view showing a bottle cap after a certain amount contents other than the contents are removed from a keeping unit.

FIG. 9a is a perspective view showing a contents removing unit of FIG. 8a and FIG. 8b; FIG. 9b is a bottom plan view a bottle cap a contents removing unit of FIG. 8a and FIG. 8b.

The slide plate 404 is constituted by a slide plate body 22, a grip 13 and a protrusion part 404. At one end of the slide plate, a grip 19 having a proper length is installed in an upper direction than the height of the body 22, and a protrusion part 404 having a proper height is installed in a downward direction than the height of the body 22.

Next, another embodiment of the present invention will be described with reference to FIG. 10 and FIG. 11.

FIG. 10 is a perspective view of a bottle cap with an opening/closing unit hinged and coupled to a block plate of the bottle cap in accordance with the present invention.

The size of the assistant cover 500 should always be smaller than the circumferential size of the block plate 3. The assistant opening 202 with upper and lower openings is provided in the block plate 3 on which the assistant cover 500 is mounted. The assistant cover 500 is sized to completely cover the assistant opening 202, and the emboss type coupling jaw 15 is installed at the four sides of the assistant opening 202, and the assistant cover is coupled by the emboss type coupling jaw installed on the four sides of the block plate. One surface of the assistant cover 500 is connected to the block plate 3 by a hinge 10.

FIG. 11 is a sectional view of the cover in FIG. 10. Regarding the description of the assistant cover 500 connected by the hinge 10 refer to FIG. 10. There is a keeping space 23 just below the assistant opening 202. The lower part of the keeping space 23 is separated from the remained space by the keeping unit 300 installed horizontally. The keeping unit 300 is integrally installed with the inner surface of the side wall 4 of the bottle cap body 100. The area of the keeping unit 300 should be equal to or smaller than the area of the assistant opening 202. The block wall 510 is installed at a certain position in a bottom part of the assistant cover 500 in a protruding shape at a right angle. The height of the block wall 510 should be shorter than the distance (height) between the upper surface 41 of the keeping unit 300 and the lower surface 16 of the block plate 3. The block wall 510 should remain within the upper surface 41 of the keeping unit 300 when the assistant cover 500 is covered with the assistant opening 202. When the assistant cover 500 is closed, an entry space is provided on the bottom surface of the block plate so as to allow the entry of a part of the assistant cover 500 of the lower part of position where the hinge 10 is installed. The size of the entry space should be wider than the folded assistant cover 500. The assistant cover 500 seals the assistant opening 202. The assistant cover 500 is formed with closed three sides of the keeping unit 300 by the bottom surface of the block plate 3, the upper surface of the keeping unit 300 and the inner surface of the bottle cap body 100. The contents enter into the keeping space 23 through the opened contents inlet 76. The contents inlet 76 is blocked by the block wall 510 of the assistant cover 500 immediately after the assistant cover 500 is opened, and the contents entering into the keeping space 23 are taken out through the assistant opening 202.

Hereinafter, with reference to FIG. 12a and FIG. 14e, the process of accommodating the contents in the keeping groove 302 will be described.

FIG. 12a to FIG. 12c are sectional views showing process of removing a certain amount contents other than the contents from a keeping unit in a bottle cap in accordance with the present invention.

FIG. 12a is a partially enlarged sectional view before passing through the protrusion unit 402. The protrusion unit 402 is still not in the keeping groove 302. FIG. 12b is a sectional view of the protrusion unit 402 passing through the keeping groove 302. FIG. 12c is a sectional view where the contents unstably staying on the keeping unit 300 other than the contents contained in the keeping groove 302 are swept away while the protrusion unit 402 passes through the keeping groove 302.

FIG. 13a to FIG. 13c, in a bottle cap in accordance with the present invention, are plan views explaining process from a time before the slide member is slid to a time after the slide member is slide into the keeping unit 300.

Only the protrusion unit 402 of the cover 200 is shown in these drawings. Refer to the description of FIG. 12a to FIG. 12c.

FIG. 14a to FIG. 14e are plan views of a keeping groove 302 provided in a keeping unit 300 in accordance with the present invention. FIG. 14a is a view showing a case where one keeping groove 302 is used, FIG. 14b is a view showing a case where two keeping grooves 302 are used, FIG. 14c is a view showing a case where three keeping grooves 302 are used, FIG. 14d is a view showing a case where four keeping grooves 302 are used, FIG. 14e is a view showing a case where five keeping grooves 302 are used. The keeping groove 302 is generally cup-shaped, hollow cylindrical shape with an open top and clogged bottom and side walls. The keeping groove 302 is integrally installed with the inner surface of the body side wall 32 and is always smaller than the area of the inner circumference of the body. The contents inlet 76 is provided in the remaining space. The diameter of the keeping groove 302 is always formed smaller than the width of the keeping unit 300.

FIG. 15 is a sectional view showing a keeping groove 302 storing contents provided in a keeping unit 300 in accordance with the present invention. The keeping groove 302 can accommodate at least than one content. FIG. 15a is a sectional view of the keeping groove 302 for storing one tablet of the contents. FIG. 15b is a sectional view of the keeping groove 302 for storing two tablets of the contents. FIG. 15c is a sectional view of the keeping groove 302 for storing three tablets of the contents. It is the upper openable keeping groove 302 capable of discretionary adjusting the depth of the groove so as to store a plurality of contents in one keeping groove 302. At least one keeping groove 302 may be installed in the keeping unit 300.

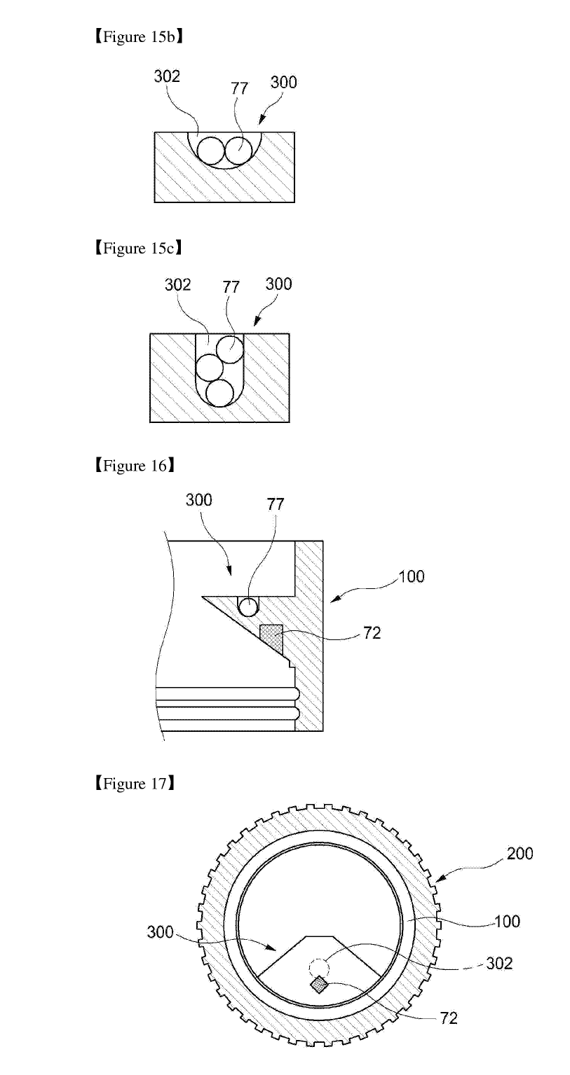

FIG. 16 is an enlarged sectional view showing a part where a dehumidifying agent case is attached to a bottom of a keeping groove 302 in accordance with the present invention. The case is installed on the bottom surface of the keeping unit 300. The inclined plane is inclined at a high rate in the direction of the outlet 102. There are a structure and a space capable of storing a dehumidifying agent between the inclined planes.

FIG. 17 is an enlarged bottom plan view showing a part where a dehumidifying agent case is attached to a bottom of a keeping groove 302 in accordance with the present invention.

FIG. 18 is a plan view showing a cover 200 that is coupled by screw threads to the bottle cap body 100 of a bottle cap, with a disconnection plate 44 and a disconnection plate removing ring 45 in accordance with the present invention. The keeping unit 300 and the disconnection plate 44 are integrally provided with inner circumference of the surface of the bottle cap body 100. The disconnection plate removing ring 45 is integrally formed by the removal ring base 46 on the upper surface of the disconnection plate 44. A separation groove 47 is provided between the outer circumferential surface of the disconnection plate 44 and the inner surface of the keeping groove 302 and the side wall. The disconnection plate 44 is separated along the separation groove 47 by the disconnection plate removing ring 45. The outlet 102 is formed at the place where the disconnection plate 44 is removed.

Hereinafter, four embodiments will be described as a method for placing a predetermined amount of contents in the keeping unit 300 using a bottle cap having the above-described configuration.

### Embodiment 1

Embodiment 1 is a basic type of a using method by coupling the bottle cap to the bottle inlet 12. The bottle cap is constituted by the cover 200 and the bottle cap body 100. Referring to FIG. 2 to FIG. 6, the embodiment 1 is as follows.

The bottle cap body 100 is fastened to the screw threads of the bottle inlet 12 in which the contents are stored in the space inside the bottle and the cover 200 coupled to the body by a screw is collectively referred to as a finished product. The using steps are 1) turning the upright standing finished product upside down about 90-180 degrees, 2) making it turned to the original upright position again, 3) separating the cover 200 from the bottle cap body 100, 4) taking out a predetermined amount of contents stored in the keeping groove 302, and 5) closing the cover 200 and storing the finished product in the proper position. The function of the present invention will be described. When the finished product is turned over, a large number of contents in the keeping space 23 enter on the keeping unit 300 and to the keeping groove 302 through the outlet 102. The number of entering contents exceeds the required amount. Other contents other than the contents stored in the keeping groove 302 should be removed. The structure used for the removal is the protrusion unit 402. The protrusion unit 402, which is integrally installed on the bottom surface of the block plate 3 of the cover 200, returns the contents to the inner space 56 of the bottle through the outlet 102 by sweeping the contents stored on the keeping unit 300, while rotating together when the cover 200 is rotated in order to open. When the cover 200 is opened, only the required contents remain in the keeping groove 302. Take it out and use it.

### Embodiment 2

As shown in FIG. 10 and FIG. 11, embodiment 2 is about a method of taking out the contents loaded into the keeping groove 302 through the opening/closing the assistant cover 500 installed to the block plate 3 of the cover 200 and the assistant opening 202. The using steps are 1) turning the upright standing finished product upside down about 90-180 degrees, 2) making it turned to the original upright position, 3) opening the assistant cover 500, where at that time, the block wall 510 blocks the contents inlet 76, 4) taking out the contents stored in the keeping groove 302 through the assistant opening 202, and 5) closing the cover 200 and storing the finished product in the proper position.

The function of the present invention will be described. When the finished product is turned over, a large number of contents in the keeping space 23 enter to the keeping unit 300 through the outlet 102. In order to make the required number only enter, the keeping space should be set according to the size of the contents.

### Embodiment 3

As shown in FIG. 7a to FIG. 9b, embodiment 3 refers to a structure in which contents loaded in the keeping groove 302 is taken out through the opening/closing of the slide plate 404 coupled with the cover 200 and a second outlet. The using steps are 1) turning the upright standing finished product upside down about 90-180 degrees, 2) making it turned to the original upright position, 3) opening the second outlet by sliding the slide plate 404, 4) taking out the contents stored in the keeping space of the keeping unit 300, and 5) closing the slide plate 404 and storing the finished product in the proper position.

### Embodiment 4

As shown in FIG. 18, embodiment 4 is a case of the cap in which the bottle cap body 100, is provided with the disconnection plate 44 and the keeping unit 300, is coupled with the cover 200 by a screw.

The using steps are 1) opening the cover 200 from the bottle cap body 100, 2) when the disconnection plate 44 is removed using the disconnection plate ring 45, the outlet 102 is created in the removed position, 3) closing the cover 200, 4) turning the upright standing finished product upside down about 90-180 degrees, 5) making it turned to the original upright position, 6) opening the cover 200, 7) taking out the contents stored the keeping groove 302, and 8) closing the cover 200. From the second using, using steps are only from step 4) to step 8).

The above functions are not limited to the case where screws are provided on the inner surface of the side wall of the bottle cap body 100 and the outer surface of the bottle inlet 12 of the present invention, and some or all of the function may be applied to the one-touch cap (So called Duma-cap, bottle+bottle cap) products.

Also, the contents devised by the present invention may be applied to some or all of other fields, such as packaging products, machinery, various facilities, and the like.

Although the above description merely corresponds to some exemplary embodiments that may be implemented by the present disclosure, as well known, the scope of the present disclosure should not be interpreted as being limited to the above-described embodiments, and all technical spirits having the same basis as that of the above-described technical spirit of the present disclosure are included in the scope of the present disclosure.

1: A bottle cap comprising:
a bottle cap body coupled with a bottle inlet of a bottle storing the contents in grain form and formed with an outlet discharging the contents stored in the bottle;
a keeping unit provided with inside of the bottle cap body, the keeping unit being formed with at least one keeping groove in which the contents discharged through the outlet are accommodated;
a contents removing unit for dropping the contents other than the contents contained in the keeping groove from the keeping unit to the bottle.

2: The bottle cap of claim 1, further comprising a cover connected with the bottle cap body, the cover uncover the keeping groove to the outside after the bottle is turned upside down and the contents are stored in the keeping groove,
wherein the contents removing unit is connected with at least one of the bottle cap body and the cover.

3: The bottle cap of claim 2, wherein the contents removing unit comprises a protrusion unit for dropping the contents other than the content contained in the keeping groove into the bottle while passing through the keeping groove by at least one movement of linear movement and rotation movement, the protrusion unit being formed by being protruded in a direction toward the bottle cap body from the surface of the cover facing the bottle cap body.

4: The bottle cap of claim 3, wherein the cover is rotatably coupled to the bottle cap body, and the protrusion unit drops the contents other than the content contained in the keeping groove into the bottle while passing through the keeping groove by relative rotation of the cover and the bottle cap body.

5: The bottle cap of claim 3, wherein the contents removing unit is formed integrally with the cover by being protruded from the bottom surface of the cover.

6: The bottle cap of claim 4, wherein the contents removing unit is formed integrally with the cover by being protruded from the bottom surface of the cover.

7: The bottle cap of claim 3, wherein the cover is coupled with the bottle cap body by undercut structure or screw structure.

8: The bottle cap of claim 4, wherein the cover is coupled with the bottle cap body by undercut structure or screw structure.

9: The bottle cap of claim 1, wherein the outlet is formed at a position corresponding to the keeping unit, the bottle cap body is coupled with an opening/closing unit which opens and closes the outlet by at least one movement of linear movement and rotation movement with respect to the bottle cap body; and
the contents removing unit comprises a protrusion unit for dropping the contents other than the contents contained in the keeping groove into the bottle while passing through the keeping groove by at least one movement of linear movement and rotation movement, the protrusion unit being formed by being protruded in a direction toward the keeping unit from the surface of the opening/closing unit facing the keeping unit.

10: A bottle cap comprising:
a bottle cap body coupled with a bottle inlet of a bottle storing the contents in grain form and formed with an outlet discharging the contents stored in the bottle;
a keeping unit provided with inside of the bottle cap body at a position corresponding to the outlet, the keeping unit being formed with at least one keeping groove in which the contents discharged through the outlet are accommodated;
an opening/closing unit for opening and closing the outlet by at least one movement of linear movement and rotation movement with respect to the bottle cap body.

11: The bottle cap of claim 10, wherein the opening/closing unit is linearly moved horizontally with the bottom surface of the bottle cap body.

12: The bottle cap of claim 10, wherein the opening/closing unit is rotatably installed centering a hinge shaft in parallel with the bottom surface of the bottle cap body.

13: The bottle cap of claim 12, wherein the opening/closing unit comprises
an opening/closing portion for opening and closing the outlet by being rotated centering the hinge shaft;
a blocking portion for blocking the inside of the bottle and the outlet when the opening/closing portion is opened, the blocking portion being extended opposite to the opening/closing portion.

14: The bottle cap of claim 1, wherein the keeping groove has a shape corresponding to a portion of the outer shape of one of contents so that one content is contained therein.

15: The bottle cap of claim 2, wherein the cover is formed with an assistant opening in order to discharge the contents contained in the keeping groove to the outside and coupled with an opening/closing unit which opens and closes the assistant opening by at least one movement of linear movement and rotation movement with respect to the cover, and the protrusion unit is formed in the opening/closing unit.

16: The bottle cap of claim 15, wherein the opening/closing unit is linearly moved horizontally with the bottom surface of the cover.

17: The bottle cap of claim 2, wherein the keeping groove has a shape corresponding to a portion of the outer shape of one of contents so that one content is contained therein.

18: The bottle cap of claim 9, wherein the keeping groove has a shape corresponding to a portion of the outer shape of one of contents so that one content is contained therein.

19: The bottle cap of claim 10, wherein the keeping groove has a shape corresponding to a portion of the outer shape of one of contents so that one content is contained therein.

20: The bottle cap of claim 13, wherein the keeping groove has a shape corresponding to a portion of the outer shape of one of contents so that one content is contained therein.
